(19) United States
(12) Patent Application Publication
(10) Pub. No.: US 2016/0229487 A1
(43) Pub. Date: Aug. 11, 2016

(54) VEHICLE OPERABLE BY MOTOR AND BY MUSCLE POWER HAVING GEAR-CHANGE ASSISTANCE

(71) Applicant: ROBERT BOSCH GMBH, Stuttgart (DE)

(72) Inventors: Gregor Dasbach, Tuebingen (DE); Peter Kimmich, Steinenbronn (DE)

(21) Appl. No.: 15/023,236

(22) PCT Filed: Sep. 4, 2014
(86) PCT No.: PCT/EP2014/068799

§ 371 Date: Mar. 18, 2016

(30) Foreign Application Priority Data
Oct. 8, 2013 (DE) 10 2013 220 293.8

(51) Int. Cl. B62M 9/132; B62M 6/50; B62M 9/10; B62M 6/45; B62M 6/55

(52) U.S. Cl. CPC B62M 9/132; B62M 6/45; B62M 6/55; B62M 9/105; B62M 6/50

(57) ABSTRACT

A vehicle operable by motor and/or by muscle power, in particular an electric bicycle, including a crank drive, an electric drive, a power supply, a chain, a gearshift having at least one first gearwheel and one second gearwheel and a chain transfer assistance unit, which assists a transfer of the chain from the first gearwheel to the second gearwheel during a gear change, and a control unit, to control the electric drive, the chain transfer assistance unit being situated on one of the gearwheels, and the control unit being configured to drive the electric drive during a gear change to move the chain so that the chain transfer assistance unit is moved into a gear change position, in which a gear change is assisted by the chain transfer assistance unit.

### FIELD OF THE INVENTION

The present invention relates to a vehicle operable by motor and by muscle power having a gear-change assistance device, and a method for operating such a vehicle for an improved gear change.

### BACKGROUND INFORMATION

Electric bicycles are believed to be understood in various designs from the related art. In general, in bicycles having derailleur gears with multiple chain rings, so-called “climbing aids” are used, which carry along the chain when shifting to a larger chain ring and make the transfer from the smaller to the larger chain ring easier. These climbing aids are situated at predefined positions on the larger chain ring. In the case of multiple chain rings on the crank drive, the positions of the climbing aids are fixed in relation to the positions of the pedals. The climbing aids are typically situated in this case in such a way that during a shifting procedure, a minimal crank torque may be always generated by the bike rider. In electric bicycles, the problem arises that pedal position and location of the chain ring are no longer uniquely fixed in relation to one another, since the two parts are separated by a freewheel. However, in particular with multiple chain rings on the crank drive, increased wear thus results during the shifting procedure.

### SUMMARY OF THE INVENTION

The vehicle according to the present invention, which is operable by motor power and/or muscle power, in particular an electric bicycle, having the features described herein has the advantage over the related art in that a shift assistance may be provided during every shifting procedure of the vehicle and therefore wear on gearwheels and chain of the vehicle may be significantly reduced. In particular, the present invention also enables the use of multiple chain rings having different numbers of teeth on the crank drive of the vehicle, without an excessively high torque being applied during the shifting procedure, even with the motor-driven assistance of the bike rider. This is achieved according to the present invention in that the vehicle includes, in addition to an electric drive and a power supply, a chain, a crank drive, and a gearshift having at least one first and one second gearwheel and a chain transfer assistance unit. This chain transfer assistance unit is situated on one of the gearwheels and assists a transfer of the chain from the first to the second gearwheel during a gear change. The chain transfer assistance unit may be, for example, an element protruding laterally on the gearwheel, over which the chain also runs during the gear change.

According to the present invention, a control unit is provided, which controls the electric drive, the control unit being configured to drive the electric drive during a gear change. The chain is moved in such a way that the chain transfer assistance unit is moved into a gear-change position, in which the chain transfer assistance unit optimally assists the gear change.

The descriptions herein specify refinements of the present invention.

The chain transfer assistance units may be particularly situated on one of the gearwheels, in particular laterally to a gearwheel. A simply constructed and effective assistance may thus be provided during the gear change.

Furthermore, the vehicle may include a sensor, which detects a gear-change intent of the bike rider. The sensor reports the gear-change intent of the bike rider to the control unit, which then generates a signal for the electric drive to move the chain transfer assistance unit into the gear-change position.

The vehicle particularly may include a manual shift unit and the sensor for detecting the gear-change intent is situated on the manual shift unit, which may be actuated by the bike rider. The manual shift unit is, for example, a shift lever or a shift twist grip.

Furthermore, the vehicle may include an electric actuator for actuating the gearshift. The signal generated on the electric actuator for the gear change may be also the signal for the electric drive to move the chain transfer assistance unit into the gear-change position.

The first and second gear wheels of the gearshift may be particularly situated on the crank drive of the vehicle. In this case, the two gearwheels therefore form two chain rings having different numbers of teeth, a chain being able to change with the aid of a front derailleur between the two chain rings, for example.

Furthermore, the vehicle may include a freewheel, which is provided between the output of the crank and a chain ring, which is engaged with the chain. The freewheel may be particularly provided as switchable, i.e., the bike rider may determine, for example, with the aid of a switch, whether or not the freewheel is to be activated.

According to another embodiment of the present invention, the electric drive is situated in the area of the crank drive. A relatively low center of gravity may thus be achieved in an electric bicycle, for example. Moving the chain transfer assistance unit rapidly into position may also be achieved.

Furthermore, the present invention relates to a method for operating a vehicle operable by motor and/or muscle power, for example, an electric bicycle. The vehicle includes an electric drive, a power supply, a gearshift having a first and a second gear wheel and a chain transfer assistance unit, a chain, a crank drive, and a control unit to control the electric drive. The chain transfer assistance unit is situated on a gearwheel. The method includes the steps of detecting a gear-change intent and driving the electric drive to move the chain, so that the chain transfer assistance unit is moved into a gear-change position, in which a gear change is assisted by the chain transfer assistance unit.

One exemplary embodiment of the present invention is described in detail hereafter with reference to the appended drawings.

### BRIEF DESCRIPTION OF THE DRAWINGS

FIG. 1 shows a schematic view of a vehicle according to one specific embodiment of the present invention.

FIG. 2 shows a schematic illustration of a chain ring arrangement according to the present invention having two chain rings.

### DETAILED DESCRIPTION

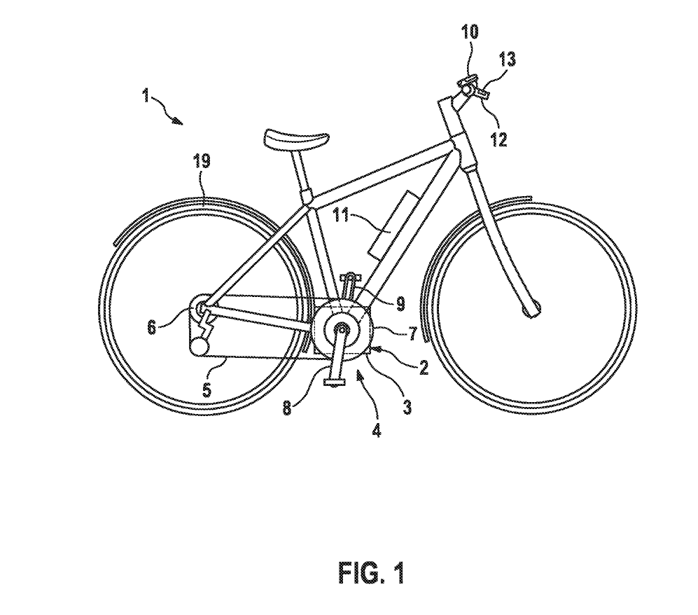

FIG. 1 shows an electric bicycle 1 according to one exemplary embodiment of the present invention.

Electric bicycle 1 according to the present invention includes a crank drive 2 and an electric drive 3, which is situated in the area of the crank drive. Furthermore, electric bicycle 1 includes a gearshift 4 having a chain 5, a plurality of pinions 6 on a rear wheel 19, and a front shifter having a chain ring arrangement 7. The front shifter includes two gearwheels 7a, 7b as chain rings.

Reference numerals 8 and 9 identify cranks of crank drive 2.

Furthermore, a power supply 11 is provided on a frame of the electric bicycle, which supplies electric drive 3 with power.

Electric bicycle 1 furthermore includes a control unit 10, which is situated in this exemplary embodiment on the handlebar of the electric bicycle. Furthermore, a shift unit 12 is situated on the handlebar, which is shifted manually by a bike rider. A sensor 13 is provided on shift unit 12, which detects a gear-change intent of the bike rider. Sensor 13 is connected to control unit 10.

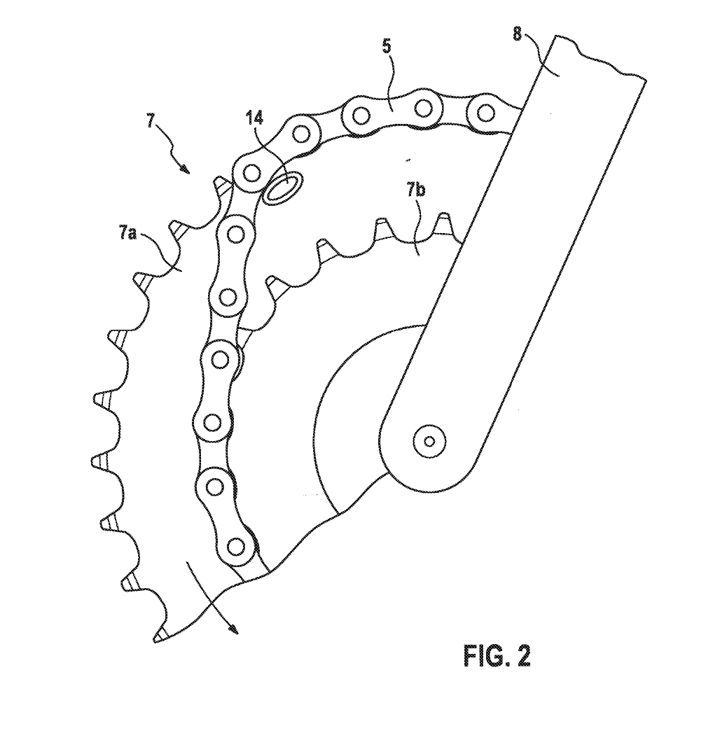

As is apparent from FIG. 2, a chain transfer assistance unit 14, which is situated laterally on gearwheel 7a, is provided on larger gearwheel 7a.

Chain transfer assistance unit 14 assists, in the event of a gear change, as shown in FIG. 2, a transfer of chain 5 from a first, small gearwheel 7b to a second, larger gearwheel 7a. A position of chain transfer assistance unit 14 may be situated in such a way that a torque exerted by the bike rider on the crank drive is minimal in this position. This is the case in particular when one of cranks 8, 9 is located at a bottom dead center or in the vicinity of the bottom dead center.

Control unit 10 is configured in such a way that in the event of a gear change, which the bike rider initiates via shift unit 12, sensor 13 transmits a corresponding signal to control unit 10. Control unit 10 thereupon drives electric drive 3, to move chain transfer assistance unit 14 into a gear-change position, in which the gear change is maximally assisted. Since a freewheel (not shown) is provided between crank drive 2 and chain rings 7, this may also take place when the bike rider stops pedaling or the pedaling slows. Electric drive 3 may rotate chain rings 7 independently of a pedal actuation by the bike rider, so that chain transfer assistance unit 14 is movable into an optimum position.

According to the present invention, wear on chain 5 and chain rings 7 may thus be minimized, since chain transfer assistance unit 14 is always positioned in the optimum position for the transfer of the chain from the first to the second gearwheel.

According to the present invention, in particular in the case of so-called front derailleurs on the crank drive, a gearshift may be implemented which has multiple chain rings.

If a torque sensor is furthermore situated on crank drive 2, as may also be the case, control unit 10 may drive electric drive 3 in each case in such a way that the shifting procedure may be carried out with an optimum torque. The control unit may detect the torque applied by the bike rider during the shifting procedure and provide the amount of torque which is lacking for the optimum torque for the shifting procedure by way of electric drive 3, or also limit it if the bike rider wishes to carry out the shifting procedure using an excessively large amount of torque.

1-10. (canceled)

11. A vehicle operable by motor and/or by muscle power, in particular an electric bicycle, including:
a crank drive;
an electric drive;
a power supply;
a chain;
a gearshift having at least one first gearwheel and one second gearwheel and a chain transfer assistance unit, which assists a transfer of the chain from the first gearwheel to the second gearwheel during a gear change, and
a control unit to control the electric drive;
wherein the chain transfer assistance unit is situated on one of the gearwheels, and
wherein the control unit is configured to drive the electric drive during a gear change to move the chain so that the chain transfer assistance unit is moved into a gear-change position, in which a gear change is assisted by the chain transfer assistance unit.

12. The vehicle of claim 11, wherein the chain transfer assistance unit is situated laterally on one of the gearwheels.

13. The vehicle of claim 11, further comprising:
a sensor which detects a gear-change intent of the bike rider.

14. The vehicle of claim 13, wherein the sensor is situated on a shift unit which is actuatable by the bike rider.

15. The vehicle of claim 11, further comprising:
an electric actuator for actuating the gearshift.

16. The vehicle of claim 15, wherein a signal for the control unit , which indicates the gear-change intent of the bike rider, is the signal of the electric actuator for shifting.

17. The vehicle of claim 11, wherein the first and second gearwheels are situated on the crank drive.

18. The vehicle of claim 17, further comprising:
a freewheel between the crank drive and the first and second gearwheels.

19. The vehicle of claim 11, wherein the electric drive is situated on the crank drive.

20. A method for operating a vehicle operable by motor and/or by muscle power, the method comprising:
detecting a gear shift intent of a bike rider, the vehicle being an electric bicycle, including a crank drive, an electric drive, a power supply, a gearshift having a first gearwheel and a second gearwheel and a chain transfer assistance unit, a chain, and a control unit to control the electric drive, the chain transfer assistance unit being situated on one of the gearwheels; and
driving the electric drive to move the chain, so that the chain transfer assistance unit is moved into a gear-change position, in which a gear change is assisted by the chain transfer assistance unit.
